(19) United States
(12) Patent Application Publication
(10) Pub. No.: US 2025/0008894 A1
(43) Pub. Date: Jan. 9, 2025

(54) Pallet System for Transporting Plants

(71) Applicant: David Steven Gardella, Medley, FL (US)

(72) Inventor: David Steven Gardella, Medley, FL (US)

(21) Appl. No.: 18/893,428

(22) Filed: Sep. 23, 2024

Related U.S. Application Data
(63) Continuation of application No. 18/223,400, filed on Jul. 18, 2023.
Application No. 18/223,400 is a continuation of application No. 17/323,144, filed on May 18, 2021, now abandoned.
(60) Provisional application No. 63/076,974, filed on Sep. 11, 2020.

(51) Int. Cl. A01G 31/02; A01G 9/029; B65D 19/38

(52) U.S. Cl. CPC A01G 31/02; A01G 9/0299; B65D 19/38

(57) ABSTRACT

A system including components and electronic modules that together form a transportation and growing system for plants and fungi is provided, the system including at least_two components, the components further including one or more of pallets, liquid collectors, posts, rails for trays, and accessories useful for managing use of the trays; and one or more electronic modules, the electronic modules further including one or more of processors, logic systems and/or controllers useful for controlling functionality of the system.

### CROSS-REFERENCES TO RELATED APPLICATIONS

This patent application claims benefit of U.S. patent application Ser. No. 18/223,400, filed Jul. 18, 2023, which claims benefit of U.S. patent application Ser. No. 17/323,144, filed May 18, 2021, which claims the benefit of U.S. Provisional Patent Application No. 63/076,974, filed Sep. 11, 2020, the contents of which are hereby incorporated by reference in their entirety.

### FIELD

The present invention relates generally to transportation pallets, and in a specific though non-limiting embodiment to a self-contained transportation pallet system designed to grow plants in an integrated shelf system that is easily mobilized throughout a variety of intermodal and retail channels.

### SUMMARY

A system including multiple components and/or electronic modules that together form a transportation and growing system for plants and fungi is provided, the system including at least two components, the components further including one or more of pallets, liquid collectors, posts, rails for trays, and accessories useful for managing use of the trays; and_one or more electronic modules, wherein the electronic modules further include one or more of processors, logic systems and/or controllers useful for controlling functionality of the system.

### DETAILED DESCRIPTION

The present invention essentially comprises a self-contained transportation pallet designed to grow plants in cooperation with an integrated shelving system.

In one example embodiment, the system comprises multiple components and/or modules that together form a transportation and growing system for plants and fungi. In various embodiments, such components comprise pallets, liquid collectors, posts, rails for trays, and various accessories useful for managing the trays. In other embodiments, the system comprises one or more processors, logic systems and/or controllers useful for controlling functionality of the system.

Ordinarily skilled artisans will recognize that such systems are useful in one or more of ocean containers, warehouses and/or greenhouses, and are easily transported to end users such as consumers, retailers and wholesalers via full container loads (FCL) and less-than-truckloads (LTL), and efficiently handled using forklifts and/or other pallet mobilization equipment either presently known or future devised.

In one embodiment, the tray system comprises a mated interlocking mechanism, thereby allowing an end user to place trays at a plurality of different heights. Those of ordinary skill in the art will appreciate that trays of various sizes and designs will admit to greater efficacy depending on the needs of the application and are not limited to any particular design to reside within the scope of the instant disclosure.

In other embodiments, light holding trays are employed in order to securely retain lights and other project peripherals (thermometers, etc.) in desired locations and positions.

In further embodiments, liquid holding trays are used to collect and retain liquids used for and/or created by the system. In other embodiments, the liquid holding trays are useful for pumping liquid transfers within and throughout the system. In other embodiments, the liquid holding trays comprise methods and means for holding and cultivating animals and other organics, including, but not limited to, shrimp, crawfish, shells, clams, oysters, lobsters and fish.

In yet another embodiment, the system comprises one or more plant holding trays useful for holding plants in place during growth. Those of ordinary skill in the art will recognize the plant holding trays are provided in a wide variety of shapes and sizes; for example, the plant holding trays can, according to need, be provided to accommodate seedling sizes, starter plants and full-sized plants. In other embodiments, trays are provided that accommodate aeroponics and/or aquaponics, for example, to accommodate the holding of soil substrates or hanging plants. In another example embodiment, the holding trays facilitate aquaponics for the cultivation of plants utilizing liquid substrate as a planting medium.

In yet another example embodiment, the system comprises one or more irrigation equipment holding trays useful for holding sprinklers, drippers, misters, vaporizers and/or a wide variety of other liquid transferring hoses and applicators.

In still further embodiments, the system comprises external energy sources to power a plurality of light trays, pumps, and irrigation equipment. Other embodiments comprise an integrated power receptacle located in the walls of the system that admit to connection from one unit to another, thereby admitting to faster commercial deployment of the subject material. In some embodiments, connection of a plurality of units is arranged in sequence; in other embodiments, connection of a plurality of units is carried out in parallel.

Those of skill in the art will appreciate that integrated power receptacles allow for connection of external power sources at associated retail locations, which is an efficient manner in which to preserve growth material using the power source(s) of refrigerated containers. In various embodiments, power receptacles allow for a plurality of power sources (individual lines) to permit individual atomization.

In other embodiments, various lighting and irrigation systems allow for client customization for individual project needs. For example, users can employ off-the-shelf timers and control systems to adjust various environmental factors such as lighting and the frequency of irrigation.

In short, the system comprises a plurality of methods and means to grow and transfer plants to end users, so that the end user can finish growing the plants and ensure creation of product as quickly and freshly as possible. In such manner, end users receive live product for use in the culinary industry, thus avoiding the burdens of inventory loss due to short shelf-life of produce and other organics.

In a specific though non-limiting embodiment, the system described herein is designed to facilitate rapid deployment of growing space in urban areas in a controlled environment, thereby admitting to plant and animal growth throughout the year.

The foregoing specification is provided for illustrative purposes only and is not intended to describe all possible aspects of the present invention. While the invention is described in detail with respect to several representative embodiments, those of ordinary skill in the art will appreciate that minor changes to the description, and various other modifications, omissions and additions may also be made without departing from the spirit or scope thereof.

1. A system comprising multiple components and/or electronic modules that together form a transportation and growing system for plants and fungi, said system comprising:
a plurality of components, wherein said components further comprise one or more of pallets, liquid collectors, posts, rails for trays, and accessories useful for managing use of the trays; and
one or more electronic modules, wherein said electronic modules further comprise one or more of processors, logic systems and/or controllers useful for controlling functionality of the system.

2. The system of claim 1, wherein said system is useful in one or more of ocean containers, warehouses and/or greenhouses.

3. The system of claim 1, wherein said system further comprises a mated interlocking mechanism, thereby allowing an end user to place trays at a plurality of different heights.

4. The system of claim 1, wherein liquid holding trays are used to collect and retain liquids used for and/or created by the system, and for pumping liquid transfers within and throughout the system.

5. The system of claim 1, said system further comprising one or more plant holding trays useful for holding plants in place during growth.

6. The system of claim 5, wherein said plant holding trays are configured in a sufficient variety of shapes and sizes as to accommodate seedling sizes, starter plants and full-sized plants.

7. The system of claim 5, wherein said plant holding trays accommodate aeroponics to accommodate the holding of soil substrates or hanging plants.

8. The system of claim 1, further comprising one or more irrigation equipment holding trays useful for holding one or more of sprinklers, drippers, misters, vaporizers and/or other liquid transferring hoses and applicators.

9. The system of claim 1, further comprising one or more external energy sources to power a plurality of light trays, pumps, and irrigation equipment.

10. The system of claim 1, wherein said connection of a plurality of units is arranged either in sequence and/or in parallel.

11. The system of claim 5, wherein said plant holding trays facilitate aquaponics for the cultivation of plants utilizing a liquid substrate as a planting medium.
